(19) United States
(12) Patent Application Publication
(10) Pub. No.: US 2025/0277898 A1
(43) Pub. Date: Sep. 4, 2025

(54) LIDAR NOISE CANCELING DEVICE AND METHOD

(71) Applicant: HYUNDAI MOBIS CO., LTD., Seoul (KR)

(72) Inventor: Ju Hyung CHOI, Seongnam-si (KR)

(73) Assignee: HYUNDAI MOBIS CO., LTD., Seoul (KR)

(21) Appl. No.: 18/911,478

(22) Filed: Oct. 10, 2024

(30) Foreign Application Priority Data
Feb. 29, 2024 (KR) 10-2024-0030192

(51) Int. Cl. G01S 7/487; G01S 17/10; G01S 17/894

(52) U.S. Cl. CPC G01S 7/4876; G01S 17/10; G01S 17/894

(57) ABSTRACT

The present disclosure relates to light detection and ranging (LiDAR) noise canceling device and method, and more particularly, to a LiDAR noise canceling device that cancels noise by using intensity information of a LiDAR reception signal and its method.

### CROSS-REFERENCE TO RELATED APPLICATIONS

This application claims priority under 35 U.S.C. § 119 to Korean Patent Application No. 10-2024-0030192, filed on Feb. 29, 2024, in the Korean Intellectual Property Office, the disclosure of which is incorporated herein by reference in its entirety.

### TECHNICAL FIELD

The following disclosure relates to light detection and ranging (LiDAR) noise canceling device and method, and more particularly, to a LiDAR noise canceling device that cancels noise by using intensity information of a LiDAR reception signal and its method.

### BACKGROUND

In general, a light detection and ranging (LiDAR) sensor is a device which may accurately depict its surroundings by emitting a laser pulse and receiving light reflected from a surrounding target object to thus measure a distance, a direction, a material, a feature, or the like to the object.

The LiDAR sensor may use a laser that may generate a pulse signal having high energy density and a short period, and thus be used for more precise observation of atmospheric physical properties and distance measurement. In addition, the LiDAR sensor may be classified into a time of flight (ToF) type and a phase-shift (PS) type based on a modulation method of a laser signal.

The ToF method is a method of measuring a distance by emitting the pulse signal from the laser and measuring a time of the pulse signal being reflected and returned from objects within a measurement range, and the PS method is a method of calculating time and distance by emitting a laser beam that is continuously modulated while having a specific frequency and measuring a phase change of the signal reflected and returned from the object within the measurement range. Additionally, recent LiDAR sensors utilize point clouds, which are data sets representing the surfaces of objects in 3D space.

The LiDAR sensor is required to perform high-sensitivity signal sensing and noise canceling due to various background noises such as sunlight or dark noise when applied in an external environment.

The LiDAR sensor conventionally uses a spatial filter or a temporal filter to cancel noise. The spatial filter uses a method of determining noise by comparing a distance difference between a specific pixel and its adjacent pixels in frame data at a specific time point t, and the temporal filter uses a method of determining whether a difference occurs in each pixel by comparing the frame data at the specific time point t with the frame data at a previous time point t-1. However, these filtering methods may have limitations in canceling noise caused by interference from sunlight, and it may be difficult to cancel noise because the light quantity changes based on the season, weather, or time. Specifically, since point clouds used by LiDAR sensors can be complex and large in their raw state, they require filtering or processing to extract specific features and remove unnecessary noise.

### SUMMARY

An embodiment of the present disclosure is directed to providing a ranging (LiDAR) noise canceling device that cancels noise in a point cloud more accurately by using the reception intensity information included in packet data of a reflected laser pulse, and its method.

In one general aspect, provided is a light detection and ranging (LiDAR) noise canceling device, the device including: a parsing unit extracting the time of flight (ToF) data and reception intensity information of each pixel by parsing packet data received from a light detection and ranging (LiDAR) reception unit; a point cloud generation unit generating point cloud information based on the ToF data of each pixel; and a filter unit providing filtered point cloud information by filtering the generated point cloud information, wherein the filter unit filters the point cloud information based on the reception intensity information of each pixel.

The filter unit may compare the reception intensity information of a first pixel with the reception intensity information of pixels adjacent to the first pixel based on the point cloud information to detect and filter out an abnormal pixel whose reception intensity information is different by a predetermined reference.

The filter unit may calculate an average value of the reception intensity information of the first pixel and the reception intensity information of the pixels adjacent to the first pixel, and filter out a pixel whose reception intensity information is different from the average value by the predetermined reference.

The filter unit may compare the reception intensity information of nth packet data with the reception intensity information of n-1th packet data based on the point cloud information to detect and filter out an abnormal pixel whose reception intensity is different by a predetermined reference.

The filter unit may compare the reception intensity information of pixels disposed at the same coordinates based on coordinate information of each pixel included in the point cloud information.

The filter unit may calculate an average value of the reception intensity information of each pixel over time based on the ToF data and reception intensity information of each pixel that are included in the packet data, and compare the average value with the reception intensity information of each pixel to detect and filter out the abnormal pixel whose reception intensity information is different by the predetermined reference.

The filter unit may generate predicted reception intensity information based on a distance of each pixel by using the average value, and compare the predicted reception intensity information with the reception intensity information of each pixel to filter out the pixel whose reception intensity information is different by the predetermined reference.

The reception intensity information may include at least one of the wavelength information, incident angle information, and amplitude information of a signal received from the LiDAR reception unit.

In another general aspect, provided is a light detection and ranging (LiDAR) noise canceling method, the method including: extracting, by a parsing unit, the time of flight (ToF) data and reception intensity information of each pixel by parsing packet data received from a light detection and ranging (LiDAR) reception unit; generating, by a point cloud generation unit, point cloud information based on the ToF data of each pixel; and providing, by a filter unit, filtered point cloud information by filtering the generated point cloud information, wherein the point cloud information is filtered by the filter unit based on the reception intensity information of each pixel.

By the filter unit, the reception intensity information of a first pixel may be compared with the reception intensity information of pixels adjacent to the first pixel based on the point cloud information to detect and filter out an abnormal pixel whose reception intensity information is different by a predetermined reference.

By the filter unit, an average value of the reception intensity information of the first pixel and the reception intensity information of the pixels adjacent to the first pixel may be calculated to filter out a pixel whose reception intensity information is different from the average value by the predetermined reference.

By the filter unit, the reception intensity information of nth packet data may be compared with the reception intensity information of n-1th packet data based on the point cloud information to detect and filter out an abnormal pixel whose reception intensity is different by a predetermined reference.

By the filter unit, the reception intensity information of pixels disposed at the

same coordinates may be compared with each other based on coordinate information of each pixel included in the point cloud information.

By the filter unit, an average value of the reception intensity information of each pixel over time may be calculated based on the ToF data and reception intensity information of each pixel that are included in the packet data, and the average value may be compared with the reception intensity information of each pixel to detect and filter out the abnormal pixel whose reception intensity information is different by the predetermined reference.

By the filter unit, predicted reception intensity information may be generated based on a distance of each pixel by using the average value, and the predicted reception intensity information may be compared with the reception intensity information of each pixel to filter out the pixel whose reception intensity information is different by the predetermined reference.

The reception intensity information may include at least one of the wavelength information, incident angle information, and amplitude information of a signal received from the LiDAR reception unit.

Other features and aspects will be apparent from the following detailed description, the drawings, and the claims.

### BRIEF DESCRIPTION OF THE DRAWINGS

FIG. 1 is a block diagram showing a light detection and ranging (LiDAR) noise canceling device according to an embodiment of the present disclosure.

FIG. 2 is an example diagram showing a point cloud where noise occurs at a LiDAR sensor according to an embodiment of the present disclosure.

FIG. 3 is an example diagram showing a point cloud where noise is canceled according to an embodiment of the present disclosure.

FIG. 4 is a flowchart showing a light detection and ranging (LiDAR) noise canceling method according to an embodiment of the present disclosure.

### DETAILED DESCRIPTION OF EMBODIMENTS

The above-mentioned objects, features, and advantages will become more obvious from the following embodiments provided in relation to the accompanying drawings. The following descriptions of specific structures and functions are provided as examples only to describe the embodiments based on a concept of the present disclosure. Therefore, the embodiments of the present disclosure may be implemented in various forms, and the present disclosure is not limited to the embodiments described in the specification or the present application. The embodiments of the present disclosure may be variously modified and have several forms, and specific embodiments are thus shown in the accompanying drawings and described in detail in the specification or the present application. However, it is to be understood that the present disclosure is not limited to the specific embodiments, and includes all modifications, equivalents, and substitutions, included in the spirit and scope of the present disclosure. Terms such as “first” or “second” may be used to describe various components, and the components are not to be construed as being limited to the terms. The terms are used only to distinguish one component and another component from each other. For example, a “first” component may be named a “second” component and the “second” component may also be named the “first” component, without departing from the scope of the present disclosure. It is to be understood that when one component is referred to as being “connected to” or “coupled to” another component, the corresponding component may be connected or coupled directly to another component or connected or coupled to another component with a third component interposed therebetween. On the other hand, it is to be understood that when one component is referred to as being “connected directly to” or “coupled directly to” another component, one component may be connected to or coupled to another component without any other component interposed therebetween. Other expressions to describe a relationship between the components, i.e., “˜between” and “directly between” or “adjacent to” and “directly adjacent to”, should be interpreted in the same manner as above. Terms used in the specification are used only to describe the specific embodiments rather than limiting the present disclosure. A term of a singular number may include its plural number unless explicitly indicated otherwise in the context. It is to be understood that terms “include”, “have”, or the like used in the specification specify the presence of features, numerals, steps, operations, components, parts, or a combination thereof, stated in the specification, and do not preclude the presence or addition of one or more other features, numerals, steps, operations, components, parts, or a combination thereof. Unless defined otherwise, it is to be understood that all the terms including technical and scientific terms used herein have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the specification. Hereinafter, a preferred embodiment of the present disclosure is described in detail with reference to the accompanying drawings. The same reference numeral in each drawing represents the same component.

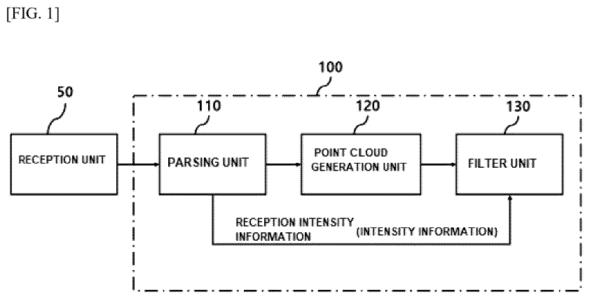

FIG. 1 is a block diagram showing a light detection and ranging (LiDAR) noise canceling device according to an embodiment of the present disclosure.

Referring to FIG. 1, the LiDAR noise canceling device according to an embodiment of the present disclosure may include a parsing unit 110, a point cloud generation unit 120, and a filter unit 130.

The parsing unit 110 may extract the time of flight (ToF) data and reception intensity information of each pixel by parsing packet data received from a light detection and ranging (LiDAR) reception unit 50. A LiDAR sensor may emit a laser pulse, and receive its reflected wave that is reflected from a surrounding target object through the reception unit 50. The parsing unit 110 may generate the ToF data and reception intensity information of each pixel by parsing the packet data for the reflected wave received through the reception unit 50. The parsing unit 110 may generate the ToF data based on a time taken for the laser pulse to be reflected from the object and returned, and generate the reception intensity information based on intensity of the laser pulse that is reflected and returned. The reception intensity information generated by the parsing unit 110 may include at least one of the wavelength information, incident angle information, and amplitude information of the pulse signal that is reflected returned, is not limited thereto, and may include all elements representing the laser pulse intensity.

The point cloud generation unit 120 may generate point cloud information based on the ToF data of each pixel that is generated by the parsing unit 110. The point cloud generation unit 120 may calculate a distance of each pixel by using the ToF data, which is data on a time taken for the pulse signal emitted from the LiDAR sensor to be reflected and returned from the object within a measurement range, and generate the point cloud information based on the calculated distance. The point cloud information generated by the point cloud generation unit 120 may include information on coordinates (x-axis, y-axis, z-axis) of each pixel.

The filter unit 130 may provide filtered point cloud information by filtering the point cloud information generated by the point cloud generation unit 120. The filter unit 130 may filter the point cloud information based on the reception intensity information of each pixel that is generated by the parsing unit 110.

In addition, the filter unit 130 may determine whether each pixel is abnormal based on the ToF data of each pixel that is generated by the parsing unit 110. The filter unit 130 may compare the ToF data of a first pixel, which is one of the pixels included in the packet data, with the ToF data of other pixels adjacent to the first pixel by using a feature that the adjacent pixels generally have similar ToF data values, and determine, as an abnormal pixel, a pixel having whose ToF data value is different by a predetermined reference. For example, the filter unit 130 may determine the corresponding pixel as the abnormal pixel when the pixels adjacent to the first pixel have a constant distance value based on the ToF data, while a specific pixel has a different distance value among the adjacent pixels.

In addition, the filter unit 130 may compare the reception intensity information of the first pixel with the reception intensity information of the pixels adjacent to the first pixel, and detect and filter out the abnormal pixel whose reception intensity information is different by a predetermined reference. A reference value for the filter unit 130 to detect the abnormal pixel may be changed based on a situation. For example, the filter unit 130 may determine the corresponding pixel as the abnormal pixel when the pixels adjacent to the first pixel have constant reflected wave reception intensity, while a specific pixel has different reception intensity among the adjacent pixels.

In addition, the filter unit 130 may calculate the average value of the reception intensity information of the pixels adjacent to the first pixel, and filter out a pixel whose reception intensity information is different from the average value previously derived based on the first pixel by the predetermined reference.

In addition, the filter unit 130 may compare the ToF data in nth received packet data with the ToF data in n-1th received packet data based on the point cloud information generated by the point cloud generation unit 120, and detect and filter out the abnormal pixel whose ToF data is different by the predetermined reference. For example, the filter unit 130 may compare the ToF data of pixels disposed at the same coordinates, which are included in the nth received packet data and the n-1th received packet data, with each other based on coordinate information included in the point cloud information. In general, the pixel at the same position appears the same in the nth received data and the n-1th received data. However, if the ToF data of the same pixel is different by the predetermined reference, the filter unit 130 may determine the corresponding pixel as the abnormal pixel.

In addition, the filter unit 130 may compare the reception intensity information in the nth received packet data with the reception intensity information in the n-1th received packet data, and detect and filter out the abnormal pixel whose reception intensity information is different by the predetermined reference. For example, the filter unit 130 may compare the reception intensity information of the pixels disposed at the same coordinates, which are included in the nth received packet data and the n-1th received packet data with each other based on the coordinate information included in the point cloud information. In general, the pixel at the same position appears the same in the nth received data and the n-1th received data. However, if the reception intensity of the same pixel is different by the predetermined reference, the filter unit 130 may determine the corresponding pixel as the abnormal pixel.

In addition, the filter unit 130 may calculate the average value of the reception intensity information of each pixel over time based on the ToF data and reception intensity information of each pixel that are included in the packet data, and compare the average value with the reception intensity information of each pixel to detect and filter out the abnormal pixel whose reception intensity is different from the average value by the predetermined reference. For example, the filter unit 130 may store the reception intensity information of the first pixel and calculate the average value. When receiving new reception intensity information of the first pixel, the filter unit 130 may compare the previously calculated average value with the newly received reception intensity to determine and filter out the abnormal pixel having the newly received reception intensity that is different by the predetermined reference.

In addition, the filter unit 130 may generate predicted reception intensity information based on the average value of the reception intensity information of each pixel over time, and compare the predicted reception intensity information with the reception intensity information of each pixel to thus filter out the pixel whose reception intensity information is different by the predetermined reference. For example, the filter unit 130 may generate the predicted reception intensity information by predicting a magnitude of the reception intensity to be received based on the average value of the reception intensity information of the first pixel. The filter unit 130 may determine and filter out the corresponding pixel as the abnormal pixel if the received reception intensity information of the first pixel is different from the predicted reception intensity information by the predetermined reference.

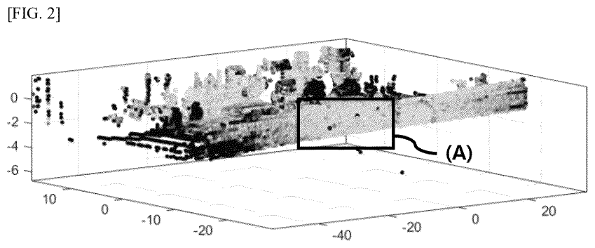

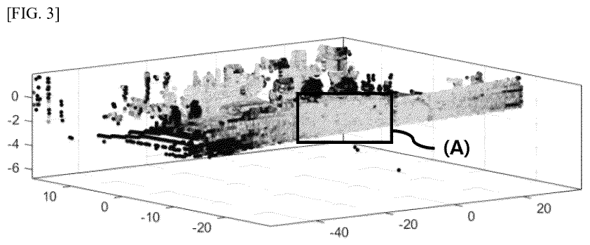

FIG. 2 is an example diagram showing the point cloud where noise occurs at the LiDAR sensor according to an embodiment of the present disclosure; and FIG. 3 is an example diagram showing a point cloud where noise is canceled according to an embodiment of the present disclosure.

First, referring to FIG. 2, noise may be detected in area A in the point cloud generated by the LiDAR noise canceling device 100 according to the present disclosure. The LiDAR noise canceling device 100 may determine whether each pixel is abnormal based on the ToF data of each pixel that is generated by the parsing unit 110. The filter unit 130 may compare the ToF data of the first pixel, which is one of the pixels included in the packet data, with the ToF data of other pixels adjacent to the first pixel by using the feature that the adjacent pixels generally have the similar ToF data values, and determine, as the abnormal pixel, the pixel having whose ToF data value is different by the predetermined reference. For example, the filter unit 130 may determine the corresponding pixel as the abnormal pixel when the pixels adjacent to the first pixel have the constant distance value based on the ToF data, while the specific pixel has the different distance value among the adjacent pixels.

In addition, the LiDAR noise canceling device 100 may compare the reception intensity information of the first pixel with the reception intensity information of the pixels adjacent to the first pixel, and detect the abnormal pixel whose reception intensity information is different by the predetermined reference. For example, the filter unit 130 may determine the corresponding pixel as the abnormal pixel when the pixels adjacent to the first pixel have the constant reflected wave reception intensity, while the specific pixel, as in a specific point in area A, has the different reception intensity among the adjacent pixels.

Referring to FIG. 3, the LiDAR noise canceling device 100 according to the present disclosure may filter out noise included in area A of the point cloud. The LiDAR noise canceling device 100 may use the ToF data and reception intensity information of each pixel to detect the abnormal pixel included in area A and filter out the corresponding pixel, thereby generating the filtered point cloud information.

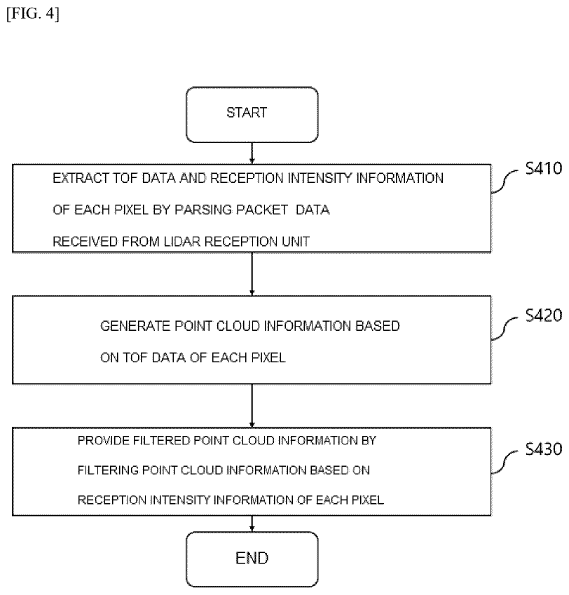

FIG. 4 is a flowchart showing a light detection and ranging (LiDAR) noise canceling method according to an embodiment of the present disclosure.

Referring to FIG. 4, the LiDAR noise canceling method according to an embodiment of the present disclosure may include: extracting, by a parsing unit 110, the time of flight (ToF) data and reception intensity information of each pixel by parsing packet data received from a light detection and ranging (LiDAR) reception unit 50 (S410); generating, by a point cloud generation unit 120, point cloud information based on the ToF data of each pixel that is generated by the parsing unit 110 (S420); and providing, by a filter unit 130, filtered point cloud information by filtering the point cloud information based on the reception intensity information of each pixel (S430).

In step S410, the time of flight (ToF) data and reception intensity information of each pixel may be extracted by the parsing unit 110 by parsing the packet data received from the LiDAR reception unit 50. A laser pulse may be emitted from a LiDAR sensor, and its reflected wave that is reflected from a surrounding target object may be received through the reception unit 50. The ToF data and reception intensity information of each pixel may be generated by the parsing unit 110 by parsing the packet data for the reflected wave received through the reception unit 50. By the parsing unit 110, the ToF data may be generated based on a time taken for the laser pulse to be reflected from the object and returned, and the reception intensity information may be generated based on intensity of the laser pulse that is reflected and returned. The reception intensity information generated by the parsing unit 110 may include at least one of the wavelength information, incident angle information, and amplitude information of the pulse signal that is reflected returned, is not limited thereto, and may include all elements representing the laser pulse intensity.

In step S420, point cloud information may be generated by the point cloud generation unit 120 based on the ToF data of each pixel that is generated by the parsing unit 110. By the point cloud generation unit 120, a distance of each pixel may be calculated by using the ToF data, which is data on a time taken for the pulse signal emitted from the LiDAR sensor to be reflected and returned from the object within a measurement range, and the point cloud information may be generated based on the calculated distance. The point cloud information generated by the point cloud generation unit 120 may include information on coordinates (x-axis, y-axis, z-axis) of each pixel.

In step S430, the filtered point cloud information may be provided by the filter unit 130 by filtering the point cloud information generated by the point cloud generation unit 120. The point cloud information may be filtered by the filter unit 130 based on the reception intensity information of each pixel that is generated by the parsing unit 110.

In addition, whether each pixel is abnormal may be determined by the filter unit 130 based on the ToF data of each pixel that is generated by the parsing unit 110. By the filter unit 130, the ToF data of a first pixel, which is one of the pixels included in the packet data, may be compared with the ToF data of other pixels adjacent to the first pixel by using the feature that the adjacent pixels generally have the similar ToF data values, and the pixel having whose ToF data value is different by the predetermined reference may be determined as the abnormal pixel. For example, the corresponding pixel may be determined as the abnormal pixel by the filter unit 130 when the pixels adjacent to the first pixel have a constant distance value based on the ToF data, while a specific pixel has a different distance value among the adjacent pixels.

In addition, by the filter unit 130, the reception intensity information of the first pixel may be compared with the reception intensity information of the pixels adjacent to the first pixel to detect and filter out the abnormal pixel whose reception intensity information is different by the predetermined reference. A reference value for detecting the abnormal pixel by the filter unit 130 may be changed based on a situation. For example, the corresponding pixel may be determined as the abnormal pixel by the filter unit 130 when the pixels adjacent to the first pixel have the constant reflected wave reception intensity, while the specific pixel has different reception intensity among the adjacent pixels.

In addition, by the filter unit 130, the average value of the reception intensity information of the pixels adjacent to the first pixel may be calculated to filter out a pixel whose reception intensity information is different from the average value previously derived based on the first pixel by the predetermined reference.

In addition, by the filter unit 130, the ToF data of nth received packet data may be compared with the ToF data of n-1th received packet data based on the point cloud information generated by the point cloud generation unit 120 to detect and filter out the abnormal pixel whose ToF data is different by the predetermined reference. For example, the ToF data of pixels disposed at the same coordinates, which are included in the nth received packet data and the n-1th received packet data, may be compared with each other by the filter unit 130 based on coordinate information included in the point cloud information. In general, the pixel at the same position appears the same in the nth received data and the n-1th received data. However, if the ToF data of the same pixel is different by the predetermined reference, the corresponding pixel may be determined as the abnormal pixel by the filter unit 130.

In addition, by the filter unit 130, the reception intensity information in the nth received packet data may be compared with the reception intensity information in the n-1th received packet data to detect and filter out the abnormal pixel whose reception intensity information is different by the predetermined reference. For example, the reception intensity information of the pixels disposed at the same coordinates, which are included in the nth received packet data and the n-1th received packet data, may be compared with each other by the filter unit 130 based on the coordinate information included in the point cloud information. In general, the pixels at the same position may appear the same in the nth received data and the n-1th received data. However, if the reception intensity of the same pixel is different by the predetermined reference, the corresponding pixel may be determined as the abnormal pixel by the filter unit 130.

In addition, by the filter unit 130, the average value of the reception intensity information of each pixel over time may be calculated based on the ToF data and reception intensity information of each pixel that are included in the packet data, and the average value may be compared with the reception intensity information of each pixel to detect and filter out the abnormal pixel whose reception intensity is different from the average value by the predetermined reference. For example, the reception intensity information of the first pixel may be stored by the filter unit 130 and the average value may be calculated. When new reception intensity information of the first pixel is received, by the filter unit 130, the previously calculated average value may be compared with the newly received reception intensity to determine and filter out the abnormal pixel having the newly received reception intensity that is different by the predetermined reference.

In addition, by the filter unit 130, predicted reception intensity information may be generated based on the average value of the reception intensity information of each pixel over time, the predicted reception intensity information may be compared with the reception intensity information of each pixel to filter out the pixel whose reception intensity information is different by the predetermined reference. For example, the predicted reception intensity information may be generated by the filter unit 130 by predicting a magnitude of the reception intensity to be received based on the average value of the reception intensity information of the first pixel. The corresponding pixel may be determined and filtered out as the abnormal pixel by the filter unit 130 if the received reception intensity information of the first pixel is different from the predicted reception intensity information by the predetermined reference.

The present disclosure can also be embodied as computer readable code or software stored on a computer-readable recording medium such as a non-transitory computer-readable recording medium. Examples of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc.

The LiDAR noise canceling device 100, and/or components thereof including, but not limited to, the parsing unit 110, the point cloud generation unit 120, and the filter unit 130, may be implemented as a computer, a processor, a microprocessor, or a circuitry or may include a processor, a microprocessor, or a circuitry. When the computer, the processor, or the microprocessor reads and executes the computer readable code stored in the computer-readable recording medium, the LiDAR noise canceling device 100, and/or components thereof including, but not limited to, the parsing unit 110, the point cloud generation unit 120, and the filter unit 130 may be configured to perform the above-described operations/method. In one example, the LiDAR noise canceling device 100, and/or components thereof including, but not limited to, the parsing unit 110, the point cloud generation unit 120, and the filter unit 130 may include a storage or memory configured as a computer-readable recording medium storing the computer readable code or software.

As set forth above, the LiDAR noise canceling device and method according to the present disclosure may cancel noise from the point cloud by using the reception intensity information included in the packet data based on the reflected wave of the laser pulse emitted from the LiDAR sensor.

In addition, the LiDAR noise canceling device and method according to the present disclosure may cancel noise from the point cloud more efficiently regardless of season, weather, or the like.

In addition, the LiDAR noise canceling device and method according to the present disclosure may cancel noise from the point cloud more accurately by determining whether noise occurs in each pixel of the packet data.

In addition, the LiDAR noise canceling device and method according to the present disclosure may store and learn the point cloud information to thus cancel noise from the point cloud more quickly.

Although the embodiments of the present disclosure are described as above, the embodiments disclosed in the present disclosure are provided not to limit the spirit of the present disclosure, but to fully describe the present disclosure. Therefore, the spirit of the present disclosure may include not only each disclosed embodiment but also a combination of the disclosed embodiments. Further, the scope of the present disclosure is not limited to these embodiments. That is, it is apparent to those skilled in the art to which the present disclosure pertains that various variations and modifications could be made without departing from the spirit and scope of the appended claims, and all such appropriate variations and modifications should be considered as falling within the scope of the present disclosure as equivalents.

What is claimed is:

1. A light detection and ranging (LiDAR) noise canceling device, the device comprising:
a parsing unit configured to extract time of flight (ToF) data and reception intensity information of each pixel by parsing packet data received from a light detection and ranging (LiDAR) reception unit;
a point cloud generation unit configured to generate point cloud information based on the ToF data of each pixel; and
a filter unit configured to filter, based on the reception intensity information of each pixel, the generated point cloud information to provide filtered point cloud information.

2. The device of claim 1, wherein the filter unit is configured to compare the reception intensity information of a first pixel with the reception intensity information of pixels adjacent to the first pixel based on the point cloud information to detect and filter out an abnormal pixel whose reception intensity information is different by a predetermined reference.

3. The device of claim 2, wherein the filter unit is configured to calculate an average value of the reception intensity information of the first pixel and the reception intensity information of the pixels adjacent to the first pixel, and to filter out a pixel whose reception intensity information is different from the average value by the predetermined reference.

4. The device of claim 1, wherein the filter unit is configured to compare the reception intensity information of an nth received pixel with the reception intensity information of an (n-1)th received pixel based on the point cloud information to detect and filter out an abnormal pixel whose reception intensity is different by a predetermined reference, and wherein n is a natural number and is equal to or greater than 2.

5. The device of claim 4, wherein the filter unit is configured to compare the reception intensity information of pixels disposed at the same coordinates based on coordinate information of each pixel included in the point cloud information.

6. The device of claim 4, wherein the filter unit is configured to calculate an average value of the reception intensity information of each pixel over time based on the ToF data and reception intensity information of each pixel that are included in the packet data, and to compare the average value with the reception intensity information of each pixel to detect and filter out the abnormal pixel whose reception intensity information is different by the predetermined reference.

7. The device of claim 6, wherein the filter unit is configured to generate predicted reception intensity information based on a distance of each pixel by using the average value, and to compare the predicted reception intensity information with the reception intensity information of each pixel to filter out the pixel whose reception intensity information is different by the predetermined reference.

8. The device of claim 1, wherein the reception intensity information includes at least one of wavelength information, incident angle information, and amplitude information of a signal received from the LiDAR reception unit.

9. A light detection and ranging (LiDAR) noise canceling method, the method comprising:
extracting, by a parsing unit, time of flight (ToF) data and reception intensity information of each pixel by parsing packet data received from a light detection and ranging (LiDAR) reception unit;
generating, by a point cloud generation unit, point cloud information based on the ToF data of each pixel; and
filtering, by a filter unit and based on the reception intensity information of each pixel, the generated point cloud information to provide filtered point cloud information.

10. The method of claim 9, further comprising:
comparing, by the filter unit, the reception intensity information of a first pixel with the reception intensity information of pixels adjacent to the first pixel based on the point cloud information to detect and filter out an abnormal pixel whose reception intensity information is different by a predetermined reference.

11. The method of claim 10, further comprising:
calculating, by the filter unit, an average value of the reception intensity information of the first pixel and the reception intensity information of the pixels adjacent to the first pixel to filter out a pixel whose reception intensity information is different from the average value by the predetermined reference.

12. The method of claim 9, further comprising:
comparing, by the filter unit, the reception intensity information of an nth received pixel with the reception intensity information of an (n-1)th received pixel based on the point cloud information to detect and filter out an abnormal pixel whose reception intensity is different by a predetermined reference,
wherein n is a natural number and is equal to or greater than 2.

13. The method of claim 12, further comprising:
comparing, by the filter unit, the reception intensity information of pixels disposed at the same coordinates with each other based on coordinate information of each pixel included in the point cloud information.

14. The method of claim 12, further comprising:
calculating, by the filter unit, an average value of the reception intensity information of each pixel over time based on the ToF data and reception intensity information of each pixel that are included in the packet data; and
comparing, by the filter unit, the average value with the reception intensity information of each pixel to detect and filter out the abnormal pixel whose reception intensity information is different by the predetermined reference.

15. The method of claim 14, further comprising:
generating, by the filter unit, predicted reception intensity information based on a distance of each pixel by using the average value; and
comparing, by the filter unit, the predicted reception intensity information with the reception intensity information of each pixel to filter out the pixel whose reception intensity information is different by the predetermined reference.

16. The method of claim 9, wherein the reception intensity information includes at least one of wavelength information, incident angle information, and amplitude information of a signal received from the LiDAR reception unit.
